(19) United States
(12) Patent Application Publication
(10) Pub. No.: US 2014/0092021 A1
(43) Pub. Date: Apr. 3, 2014

(54) METHOD AND SYSTEM FOR ENTERING TEXT USING A REMOTE CONTROL

(71) Applicant: THOMSON LICENSING, Issy de Moulineaux (FR)

(72) Inventor: Evan Michael FOOTE, Carmel, IN (US)

(73) Assignee: THOMSON LICENSING, Issy de Moulineaux (FR)

(21) Appl. No.: 13/629,876

(22) Filed: Sep. 28, 2012

(51) Int. Cl. G06F 3/02

(52) U.S. Cl. 345/169

(57) ABSTRACT

The disclosed embodiments relate to a system and method for entering text using a remote control. More specifically, there is provided a method comprising identifying a plurality of section keys for a keyboard display. Each of the section keys is associated with each of a plurality of sections of the keyboard display. The method also includes determining a plurality of remote key identifiers for a selected section of the keyboard display. The selected section is associated with a selected section key on the remote control. The method further includes determining a selected character of the keyboard display based on a selected second key on the remote control.

### FIELD OF THE INVENTION

The present disclosure involves remote-controlling a multimedia device. More specifically, the present disclosure relates to a system for entering text using a remote control.

### BACKGROUND OF THE INVENTION

This section is intended to introduce the reader to various aspects of art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Home theater and entertainment systems include any number of components, including various forms of display, sound, and media. These components may each use various parameters for their particular functions. For example, parental controls may request passwords or other content restriction parameters. In many cases, the components provide menus wherein a human user enters these parameters as text using a remote control. Typically, the remote control is a simple device, or not particularly configured to ease the entry of text characters. As such, text entry is typically clumsy, inefficient, and frustrating for the user.

An improved system and/or method for entering text with a remote control is desirable.

### SUMMARY OF THE INVENTION

Certain aspects commensurate in scope with the originally claimed concepts are set forth below. It should be understood that these aspects are presented merely to provide the reader with a brief summary of certain forms the embodiments might take and that these aspects are not intended to limit the scope of the disclosure. Indeed, the invention may encompass a variety of aspects that may not be set forth below.

The disclosed embodiments relate to a system and method for entering text using a remote control. More specifically, there is provided a system and method comprising selecting a section of an on-screen keyboard display using a first button on the remote control, and selecting a key of the on-screen keyboard display using a second button on the remote control, wherein the first button indicates the section, and the second button indicates the key.

### BRIEF DESCRIPTION OF THE DRAWINGS

Advantages present disclosure may become apparent upon reading the following detailed description and upon reference to the drawings in which:

FIG. 1 is a simplified block diagram of an exemplary system in accordance with one embodiment of the present disclosure;

FIGS. 2A-2B are diagrams of an exemplary on-screen keyboard display in accordance with embodiments of the present disclosure; and

FIG. 3 is a flow chart illustrating an exemplary technique for entering text using a remote control in accordance with embodiments of the present disclosure.

### DETAILED DESCRIPTION

One or more specific embodiments of the present disclosure will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

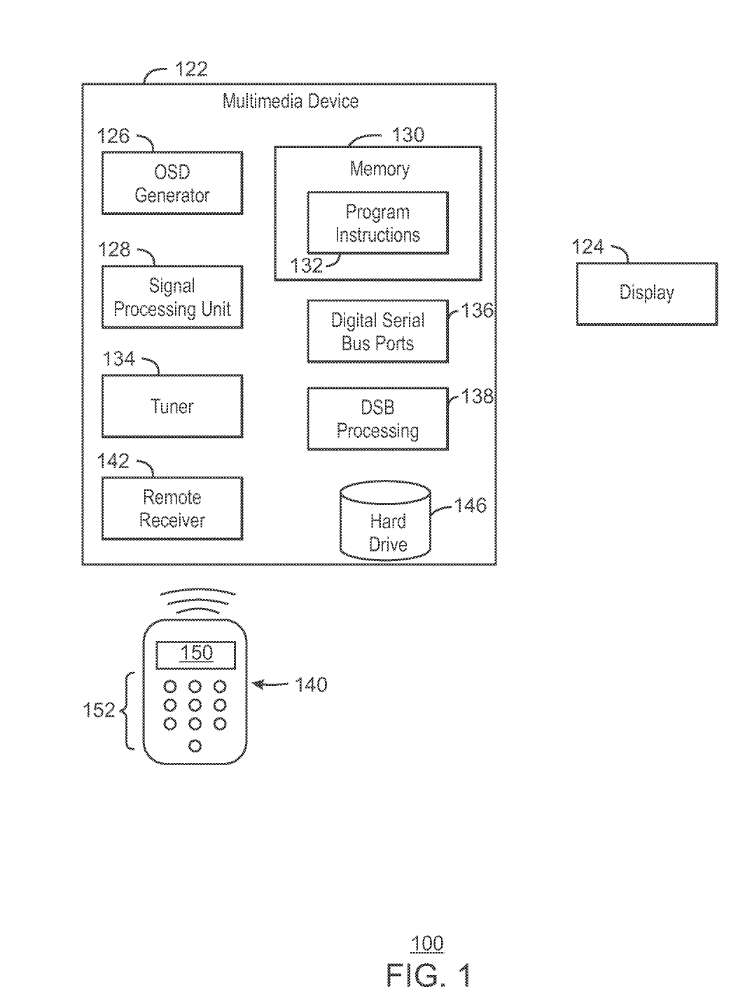

Turn initially to FIG. 1, a block diagram of an exemplary system in accordance with one embodiment is illustrated and generally designated by a reference numeral 100. FIG. 1 illustrates an exemplary system 100 incorporating and operable according to the principles of the present disclosure. Being exemplary, the system 100 represents physical embodiments of a multimedia device 122 and display 124, operable in accordance with the principles of the present disclosure.

The multimedia device 122 may be a device for processing multimedia signals, such as a set top box device, digital video recorder, digital video disc (DVD) player, high-definition (HD) disc player, streaming device, and the like. The multimedia device 122 may be connected, or otherwise coupled to, the display 124. Alternatively, in an example system 100, the multimedia device 122 may be a television, which includes the display 124. The display 124 may include speakers (not shown). The speakers may be connected, or otherwise coupled to, the display 124 or the multimedia device 122. The multimedia device 122 has basic functionality and features consistent with typical television apparatus as well as the present functionality described herein.

The multimedia device 122 is operable, configured or adapted to process digital television signals, digital audio/video (NV) content and the like (collectively, digital content), as well as analog television signals and analog NV content and the like (collectively, analog content) from various input sources available for the multimedia device 122. It is noted, however, that the multimedia device 122 may process only digital content. The various input sources may include a A/V signals from a satellite or cable provider, tunable digital content, DVDs, HD video and audio content, and the like. In one embodiment, the source may be a server that streams NV content over a local area network, or a wide area network, such as the Internet. The multimedia device 122 may also include a hard drive 146, or other storage device, for recording content.

The multimedia device 122 includes an on-screen display (OSD) generator 126 that is operable to provide the graphics, text and the like for on-screen menus on the display 124. The display 124 is further operable to display one or more menus or user selectable options in response to user input, television system signals, signals from components, and accept user input for selection of various options. The multimedia device 122 includes a signal processing unit 128 (e.g. a broadcast, cable, satellite, Internet protocol (IP) or similar signal processing unit) for functioning in the manner described herein.

In addition to processing and playing content, the multimedia device 122 is also configured, adapted or operable to provide for display: text, graphics, pictures or the like, particularly for on-screen menus, messages or the like in accordance with the principles of the present disclosure. The multimedia device 122 may also accept user input for controlling the multimedia device 122, by accessing various menus for selection of menu choices, defaults, and the like.

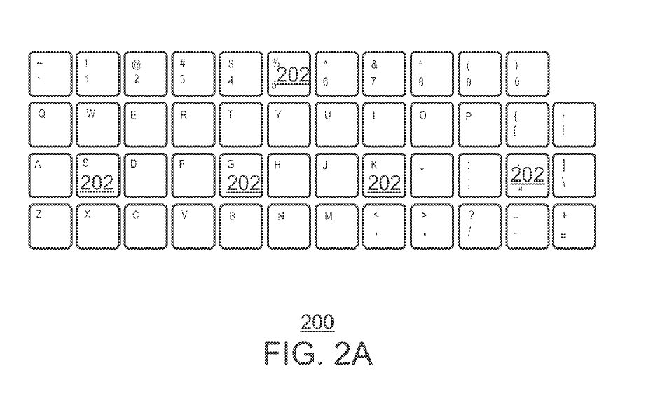

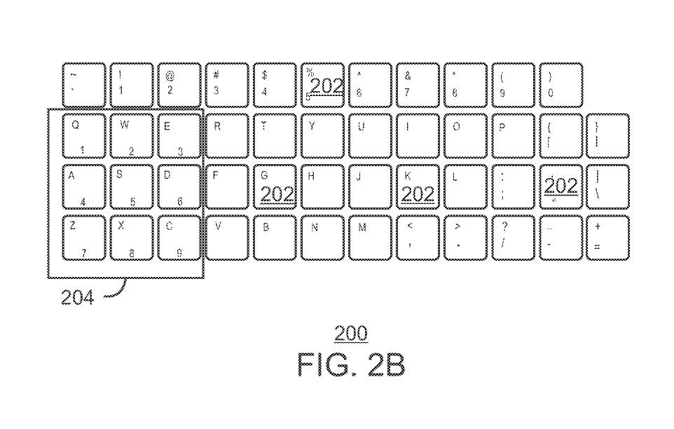

The multimedia device 122 accepts user input via a remote controller 140 that transmits user initiated input signals to a remote control signal receiver 142. The remote 140 and remote receiver 142 may use infrared (IR), radio frequency (RF), or other transmission means. In an example embodiment, the display 124 also includes a remote receiver (not shown). The remote controller 140 includes selection buttons 150 and numeric buttons 152, that are configured for easing entry of text characters in an on-screen menu. The selection buttons 150 may each be uniquely colored, and are described in greater detail with respect to FIGS. 2A, 2B. In one embodiment, the remote 140 includes other buttons (not shown) that may be used in accordance with the operation of the numeric buttons 152 herein. The remote controller 140 is used to provide input with respect to menu options or choices, as well as for typical remote features such as, but not limited to, channel change inputs, volume control inputs, transport command inputs, settings inputs, and the like. The remote controller 140 may also be used to control the display 124 or other component connected, or otherwise coupled to, the multimedia device 122.

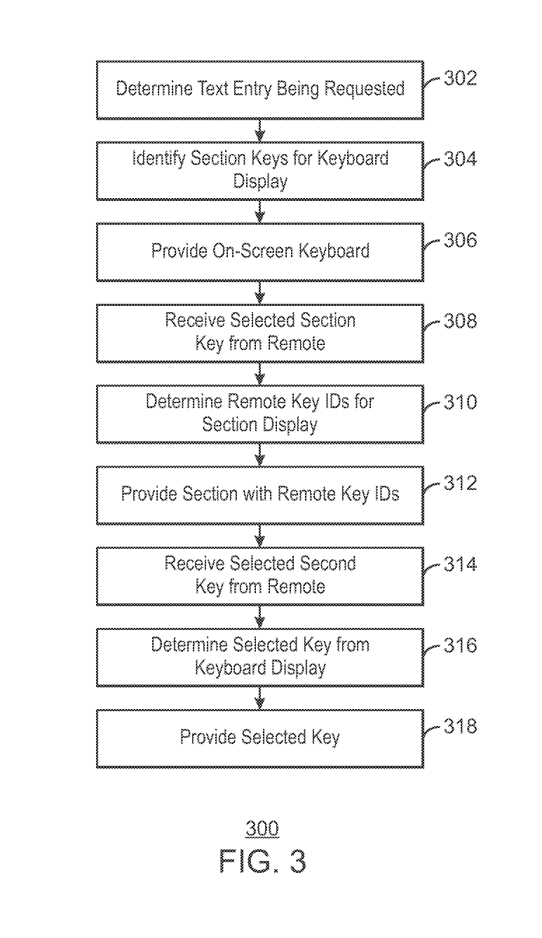

The multimedia device 122 may include a signal processing unit 128 that is operable, configured or adapted to process digital such as MPEG2 digital signals. The signal processing unit 128 may also provide analog signal processing if the multimedia device 122 supports analog signals. The signal processing unit 128 also provides control of the various apparatus components, features and functions of the multimedia device 122, and the like. The multimedia device 122 further includes memory 130 storing program instructions 132. The program instructions 132 are used by the multimedia device 122 (i.e. the processing 128 and the digital serial bus processing 138) for operation of the multimedia device 122 in accordance with the present principles. Additionally, the memory 130 may include a mapping. The mapping is described in greater detail with respect to FIG. 3.

The multimedia device 122 may include a tuner 134 that is operable to receive tunable digital content. Additionally, the multimedia device 122 may include digital serial bus ports 136 for connection and communication with one or more DSB-compliant devices or components. The digital serial bus compliant devices or components may be a digital recording device having a hard disk drive, a DSB box, or the like. In an example embodiment, the digital serial bus is an IEEE 1394 digital serial bus and the components connected to the DSB ports 136 are IEEE 1394 compliant devices. The processing element 138 would thus perform IEEE1394 processing. Thus, the multimedia device 122 provides for recording functionality over the IEEE 1394 bus by establishing a connection between an IEEE 1394 compliant recordable device and an IEEE 1394 compliant recording device.

In accordance with the claimed subject matter, the system 100 provides for display an on-screen menu that requests a text entry. In response, the system 100 provides for display an on-screen keyboard for selection of text characters for the requested entry. Specifically, the remote 140 is used to reduce each text character selection to a two-step process: section selection, and key selection, described in greater detail with respect to FIGS. 2A and 2B.

FIG. 2A is an exemplary on-screen keyboard display 200 in accordance with embodiments of the present disclosure. The keyboard display 200 includes a number of keys, including five highlighted keys 202. Each highlighted key 202 corresponds to a section of the keyboard. Each highlighted key 202 also corresponds to one of the section keys 150 on the remote control 140. As stated previously, the memory 130 may include the mapping. The mapping is a file that associates the section keys 202 with corresponding sections in the keyboard display 200. The keys highlighted on the display 124 may be based on this mapping. By pressing the appropriate section key 150 on the remote 140, the user selects the corresponding section of the keyboard display 200. In one embodiment of the claimed subject matter, the section keys 150 are each a different color. In such an embodiment, each highlighted key is displayed using the color of the corresponding section key. Further, the multimedia device 122 may also provide an interface to enable assigning each section of the on-screen keyboard display 200 to a section key 150 on the remote 140.

FIG. 2B is the exemplary on-screen keyboard display 200 in accordance with embodiments of the present disclosure. The on-screen keyboard display 200 includes selected section 204, with the corresponding keys highlighted. Each key in the selected section includes the text character and a remote key identifier corresponding to a key on the remote control 140. In one embodiment of the claimed subject matter, the multimedia device 122 provides an interface to map each key in a section to a corresponding key on the remote control 140. This may be included in the mapping. In another embodiment, the association between the keys in a section and the keys on the remote control 140 may be performed automatically. For example, the section key and the eight surrounding keys may be included in a section that maps to a corresponding numeric keypad layout on the remote control 140. By pressing a numeric key 152, the user may select the corresponding text character for the requested text entry. For example, to select the text character, “Q,” the user presses the numeric key 152 labeled, “1.” It is noted that the on-screen keyboard display 200 is merely an example. Embodiments of the claimed subject matter may include more keys, fewer keys, or a different character set.

FIG. 3 is a flow chart illustrating an exemplary method 300 for entering text using a remote control in accordance with embodiments of the present disclosure. At block 302, it may be determined that a text entry is being requested. In order to present the keyboard display 200 with highlighted section keys 202, at block 304, the section keys may be identified. At block 306, on-screen keyboard may be provided for display with the section keys highlighted. As stated previously, the on-screen keyboard display 200 includes highlighted keys, indicating different sections 204. The highlighted section keys 202 may each have a different color corresponding to a colored section key 150 on the remote 140. At block 308, the multimedia device 122 receives the selected section key 150 from the remote 140. This may occur when the user presses the section key on the remote 140 with the same color as the corresponding section key 202 on the keyboard display 200.

As stated previously, in the keyboard display 200, the selected section includes remote key IDs for each key. Accordingly, at block 310, an association between the remote key IDs and the keys in the selected section is determined. At block 312, the selected section may be provided. The remote key IDs are provided in association with the keys in the selected section. At block 314, the multimedia device 122 receives a second selected key from the remote 140. The second key may be one of the numeric keys 152 selected by the user. At block 316, the key selected from the keyboard display 200 may be determined. For example, mapping may identify the selected key from the keyboard display 200. At bloc 318, the character in the selected key may be provided for display. In one embodiment, the text character may be provided to a text entry requester, e.g., a device connected to the DSB ports 136.

While the concepts herein may be susceptible to various modifications and alternative forms, specific embodiments have been shown by way of example in the drawings and will be described in detail herein. However, it should be understood that the concepts are not intended to be limited to the particular forms disclosed. Rather, the invention is to cover all modifications, equivalents and alternatives falling within the scope of the invention as defined by the following appended claims.

1. A method comprising:
identifying a plurality of section keys (202) for a keyboard display (200), wherein each of the section keys (202) is associated with each of a plurality of sections (204) of the keyboard display (200);
determining a plurality of remote key identifiers for a selected section (204) of the keyboard display (200), wherein the selected section (204) is associated with a selected section key (150) on a remote control (140); and
determining a selected character of the keyboard display (200) based on a selected second key (152) on the remote control (140).

2. The method of claim 1, comprising:
providing the keyboard display (200) comprising a plurality of highlighted keys (202), wherein each of the highlighted keys (202) represents one of the sections (204), wherein each of the sections (204) comprises a plurality of keys;
providing a selected section (204) of the keyboard display (200) based on the selected section key (150); and
providing the selected character.

3. The method of claim 2, comprising:
receiving the selected section key (150) from the remote control (140); and
receiving the selected second key (152) from the remote control (140).

4. The method of claim 3, comprising:
displaying the keyboard display (200);
displaying the selected section (204); and
displaying the selected character in association with the text entry.

5. The method of claim 1, wherein providing the selected section (204) of the on-screen keyboard (200) comprises displaying a remote key identifier in association with each key of the selected section (204).

6. The method of claim 1, wherein the selected section key (150) comprises a color associated with a highlighted key (202) of the keyboard display (200) representing the selected section (204).

7. The method of claim 1, wherein the selected second key (152) comprises an identifier provided in association with the selected character.

8. The method of claim 1, comprising determining that a text entry is requested in association with the multimedia device (122) and the remote control (140).

9. A multimedia device (122) configured to:
determine that a text entry is requested in association with the multimedia device (122) and a remote control (140) for the multimedia device (122);
identify a plurality of section keys (202) for a keyboard display (200), wherein each of the section keys (202) is associated with each of a plurality of sections (204) of the keyboard display (200);
determine a plurality of remote key identifiers for a selected section (204) of the keyboard display (200), wherein the selected section (204) is associated with a selected section key (150) on a remote control (140); and
determine a selected character of the keyboard display (200) based on a selected second key (152) on the remote control (140).

10. The multimedia device (122) of claim 9, configured to:
provide the keyboard display (200) comprising a plurality of highlighted keys (202), wherein each of the highlighted keys (202) represents one of the sections (204), wherein each of the sections (204) comprises a plurality of keys;
provide a selected section (204) of the keyboard display (200) based on the selected section key (150); and
provide the selected character.

11. The multimedia device of claim 10, further comprising a display configured to:
display the keyboard display (200);
display the selected section (204); and
display the selected character in association with the text entry.

12. The multimedia device of claim 11, configured to determine an association between each of a plurality of remote key identifiers and each key of the selected section.

13. The multimedia device of claim 12, configured to display the remote key identifiers in association with an associated key of the selected section (204).

14. The multimedia device of claim 9, wherein the selected section key (150) comprises a color associated with a highlighted key (202) of the keyboard display (200) representing the selected section (204).

15. The multimedia device of claim 9, wherein the selected second key (152) comprises an identifier displayed in association with the selected character.
